(19) United States
(12) Patent Application Publication
(10) Pub. No.: US 2026/0167249 A1
(43) Pub. Date: Jun. 18, 2026

(54) STEERING DEVICE

(71) Applicant: TOYODA GOSEI CO., LTD., Kiyosu-shi (JP)

(72) Inventors: Itsuhiko HIROTA, Kiyosu-shi (JP); Akitoshi NAGANAWA, Kiyosu-shi (JP)

(21) Appl. No.: 19/286,672

(22) Filed: Jul. 31, 2025

(30) Foreign Application Priority Data
Sep. 19, 2024 (JP) 2024-162604
Sep. 19, 2024 (JP) 2024-162611

(51) Int. Cl. B62D 1/04; B60Q 3/283

(52) U.S. Cl. CPC B62D 1/046; B60Q 3/283

(57) ABSTRACT

A steering device mounted on a vehicle includes:
a boss portion coupled to a steering shaft of the vehicle;
a pad that covers the boss portion from rear, the pad including a first lighting unit, a second lighting unit disposed at a position different from a position of the first lighting unit, and a protrusion disposed between the first lighting unit and the second lighting unit when viewed from a front-rear direction, the protrusion protruding forward from a front face of the pad;
a first light source that is disposed in front of the pad and emits light for lighting the first lighting unit;
a second light source that is disposed at a position, in front of the pad, different from a position of the first light source and emits light for lighting the second lighting unit;
a circuit board on which the first light source and the second light source are mounted; and
a holding member that is coupled to the protrusion and holds the circuit board.

### CROSS-REFERENCE TO RELATED APPLICATIONS

The present application claims priority from Japanese Patent Application No. 2024-162604 of Hirota et al., filed on Sep. 19, 2024, and Japanese Patent Application No. 2024-162611 of Hirota et al., filed on Sep. 19, 2024, the disclosures of which are hereby incorporated into the present application by reference.

### BACKGROUND

### Technical Field

The present invention relates to a steering device mounted on a vehicle.

### Description of Related Art

In the related art, a configuration has been widely known in which a pad of a steering device is provided with a lighting unit used for calling attention to a driver by light, decoration, or the like. For example, WO 2023/163325 A1 discloses a configuration in which a pad is provided with a plurality of lighting units disposed in parallel in the left-right direction and an optical unit for lighting the plurality of lighting units. The optical unit is attached to a front face (reverse side) of the pad, and includes a cover member coupled to the front face of the pad, a circuit board on which a plurality of light sources is mounted, and a holding member that holds the circuit board.

In the configuration disclosed in WO 2023/163325 A1, the cover member has a protrusion, as a part for suppressing positional displacement of the circuit board with respect to the holding member, which protrudes forward and comes into contact with the circuit board to press the circuit board against the holding member. The protrusion is disposed between two adjacent lighting units when viewed from the front-rear direction, and is not directly coupled to the holding member.

Here, considering the role of the optical unit of lighting the lighting unit, there is a high possibility that the position between the plurality of lighting units in which the protrusion is disposed is disposed near the center of the optical unit. Therefore, when the protrusion and the holding member are not coupled, there is a high possibility that the cover member attached to the pad and the holding member are not coupled near the center of the optical unit. In this case, the coupling strength between the entire optical unit and the pad is weak, and the optical unit may be detached from the pad when an external force is applied.

### SUMMARY

An object of the present invention is to provide a steering device capable of firmly coupling a pad and a holding member holding a circuit board.

A typical configuration of a steering device according to the present invention is as follows.

A steering device mounted on a vehicle includes:
a boss portion coupled to a steering shaft of the vehicle;
a pad that covers the boss portion from rear, the pad including a first lighting unit, a second lighting unit disposed at a position different from a position of the first lighting unit, and a protrusion disposed between the first lighting unit and the second lighting unit when viewed from a front-rear direction, the protrusion protruding forward from a front face of the pad;
a first light source that is disposed in front of the pad and emits light for lighting the first lighting unit;
a second light source that is disposed at a position, in front of the pad, different from a position of the first light source and emits light for lighting the second lighting unit;
circuit board on which the first light source and the second light source are mounted; and
a holding member that is coupled to the protrusion and holds the circuit board.

### BRIEF DESCRIPTION OF THE DRAWINGS

FIG. 1 is a view of the surroundings of a driver seat of a vehicle equipped with a steering wheel when viewed from the left side;

FIG. 2 is a front view of the steering wheel;

FIG. 3 is a front view of the steering wheel in a state where an airbag is inflated;

FIG. 4 is a cross-sectional view of the steering wheel taken along line A-A illustrated in FIG. 2;

FIG. 5 is a perspective view of an optical unit;

FIG. 6 is a front view of the optical unit and a pad.

FIG. 7 is an exploded perspective view of the optical unit and the pad;

FIG. 8 is an exploded perspective view of the optical unit and the pad;

FIG. 9 is an exploded perspective view of a pad of the optical unit; and

FIG. 10 is an enlarged cross-sectional view of the surroundings of a lighting unit of the steering wheel and the optical unit.

### DESCRIPTION OF THE PREFERRED EMBODIMENTS

Preferred embodiments of the present invention are described below with reference to accompanying drawings. However, the invention is not limited to the embodiments disclosed herein. All modifications within the appended claims and equivalents relative thereto are intended to be encompassed in the scope of the claims.

Hereinafter, a configuration of a steering wheel 10 as a steering device according to an embodiment of the present invention will be described with reference to the drawings. The dimensions, materials, shapes, relative arrangements, and the like of components described below are not intended to limit the scope of the present invention only to them unless otherwise specified.

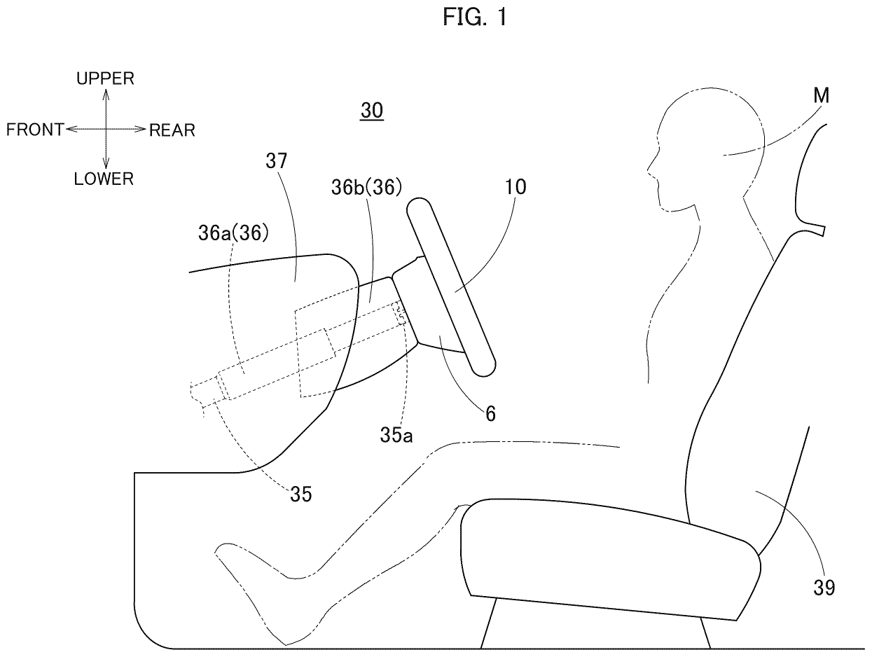

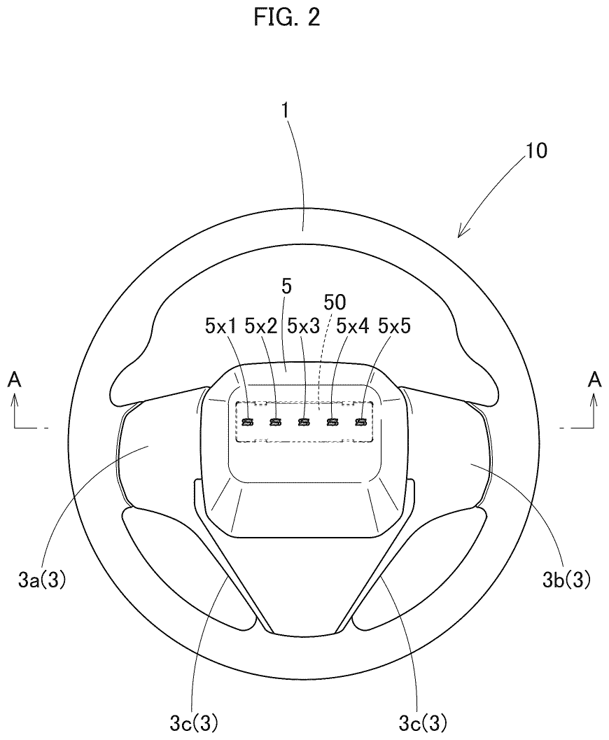

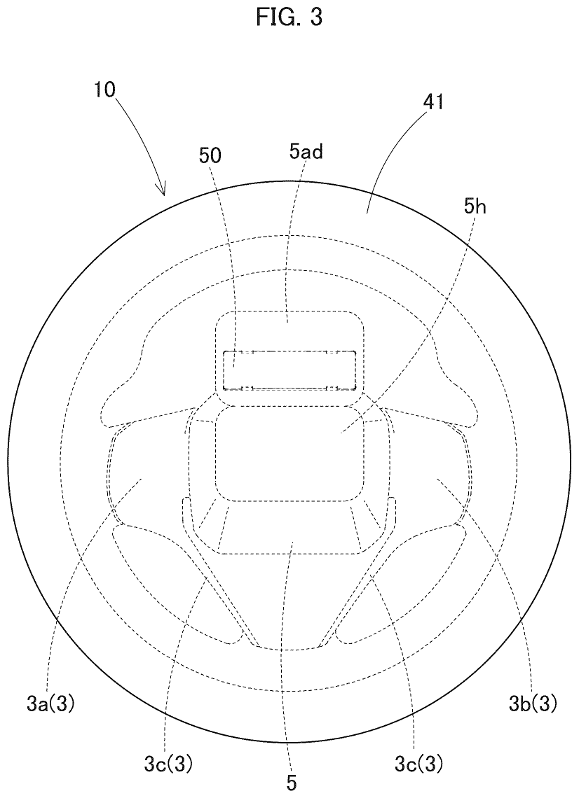

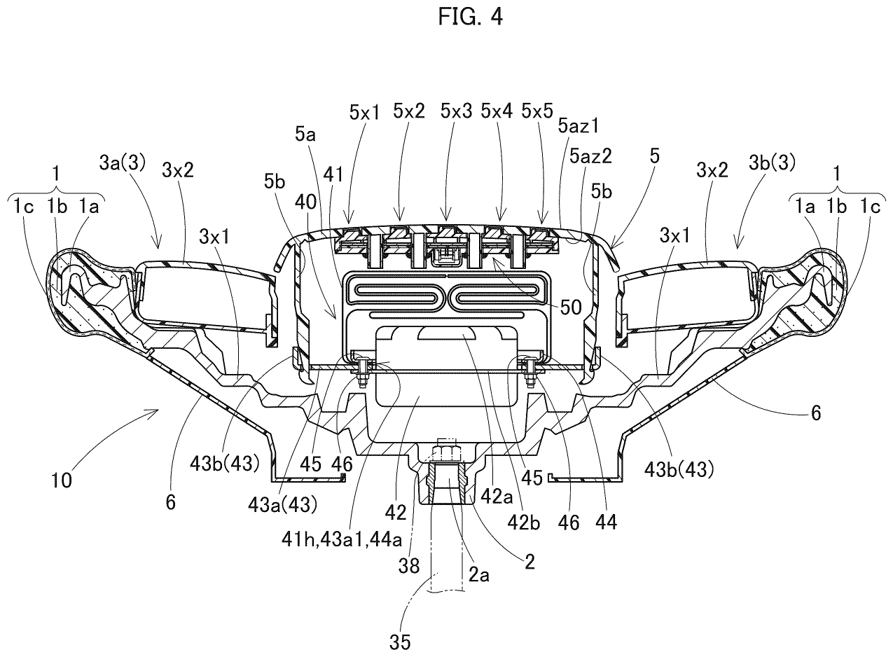

FIG. 1 is a view of the surroundings of a driver seat 39 of a vehicle 30 equipped with a steering wheel 10 when viewed from the left side, and illustrates a driver M seated on the driver seat 39 by a two-dot chain line. FIG. 2 is a front view of the steering wheel 10, FIG. 3 is a front view of the steering wheel 10 in a state where an airbag 41 is inflated. FIG. 4 is a cross-sectional view of the steering wheel 10 taken along line A-A illustrated in FIG. 2.

In the following description, unless otherwise specified, each direction described for the steering wheel 10 means a direction in a state where the steering wheel 10 is mounted on the vehicle 30 illustrated in FIG. 1. That is, the front-rear direction substantially coincides with a traveling direction and an opposite direction when the vehicle 30 travels straight, or a front direction and a rear direction when viewed from the driver M. The left-right direction means a left direction and a right direction when the vehicle 30 travels straight, specifically, a left direction and a right direction when viewed from the driver M. The up and down direction substantially coincides with an upward direction and a downward direction in the vertical direction.

As illustrated in FIG. 1, the steering wheel 10 (steering device) is mounted on the vehicle 30 by being coupled to a steering shaft 35 of the vehicle 30. The vehicle 30 includes a steering column 36 including a column tube 36a that partially covers the outer peripheral portion of the steering shaft 35 to support the steering shaft 35, and a column cover 36b that covers a portion of the steering shaft 35 protruding rearward from an instrument panel 37. The steering wheel 10 is attached to a rear end portion 35a of the steering shaft 35 protruding rearward from the instrument panel 37.

As illustrated in FIGS. 2 to 4, the steering wheel 10 includes a grip portion 1 gripped by the driver M when the vehicle 30 is steered, a boss portion 2 coupled to the steering shaft 35, and a spoke portion 3 coupling the grip portion 1 and the boss portion 2. In addition, the steering wheel 10 includes a pad 5 that covers the boss portion 2 and the airbag 41 in the folded state from rear and constitutes part of a rear side exterior of the steering wheel 10, and an optical unit 50 that is attached to the front face (reverse side) of the pad 5 and lights lighting units 5x1 to 5x5 of the pad 5. In addition, the steering wheel 10 includes a lower cover 6 constituting a front side exterior, and an airbag unit 40 disposed between the boss portion 2 and the pad 5 and including the airbag 41.

The grip portion 1 includes a core material la made of metal, an intermediate material 1b made of a synthetic resin such as polyurethane covering the core material la, and a surface material 1c such as leather wound around an outer peripheral portion of the intermediate material 1b. The driver M grips and rotationally steers the grip portion 1 to rotate the steering shaft 35 and change the traveling direction of the vehicle 30.

The boss portion 2 is a metal member coupled to the steering shaft 35, and has a shaft hole 2a through which the steering shaft 35 is inserted. The boss portion 2 and the steering shaft 35 are coupled by fixing the boss portion 2 and the steering shaft 35 to each other with a nut 38 in a state where the steering shaft 35 is inserted and fitted into the shaft hole 28.

The spoke portion 3 includes a left spoke portion 3a and a right spoke portion 3b extending from the boss portion 2 to the left and right, respectively, and a lower spoke portion 3c extending downward. The spoke portion 3 includes a metal core material 3x1 coupling the core material la of the grip portion 1 and the boss portion 2, and a resin spoke cover 3x2 covering the core material 3x1. The core material 1a of the grip portion 1, the boss portion 2, and the core material 3x1 of the spoke portion 3 are integrally molded by die casting.

The pad 5 is made of a synthetic resin in the present embodiment. The pad 5 includes a cover portion 5a that covers the rear of the airbag 41 in the folded state and constitutes part of the exterior of the steering wheel 10, and a coupling portion 5b that extends forward from the cover portion 5a and is coupled to a case 43 of the airbag unit 40.

The cover portion 5a of the pad 5 is broken by the pressure received from the airbag 41 when the airbag 41 is inflated to form an opening 5h, and the airbag 41 is delivered from the opening 5h. The cover portion 5a has a substantially rectangular door portion 5ad that rotates upward at the time of breaking (see FIG. 3). The airbag 41 is inflated and comes into contact with the door portion 5ad, and the door portion Sad rotates as described above, whereby the opening 5h is formed in the cover portion 5a. Note that the edge of the door portion 5ad of the cover portion 5a is a fragile portion (not illustrated) in which the cover portion 5a is cut out from an reverse side 5az2 to be thin so as to be easily broken by the pressure received from the airbag 41.

In addition, the cover portion 5a has five lighting units 5x1 to 5x5 which are arranged in parallel in the left-right direction and are lit as decorations of the pad 5. The lighting units 5x1 to 5x5 are an example of a first lighting unit, a second lighting unit disposed at a position different from that of the first lighting unit, and a third lighting unit disposed at a position different from those of these lighting units. In the present embodiment, the lighting units 5x1 to 5x5 are all lit so that the character “S” is displayed. However, the present invention is not limited thereto, and for example, the lighting units 5x1 to 5x5 may be configured to light up so as to display different characters, may be configured to light up so as to display other types of characters such as katakana and Arabic characters, or may be configured to light up in other forms such as a dot form.

Further, the optical unit 50 including a light source and the like for lighting the lighting units 5x1 to 5x5 is attached to the reverse side 5az2 of the cover portion 5a (the front face of the pad 5). A detailed configuration of the lighting units 5x1 to 5x5 and the optical unit 50 will be described later. Since the optical unit 50 is attached to the reverse side of the door portion 5ad of the cover portion 5a, the optical unit 50 rotates upward together with the door portion 5ad along with the inflation of the airbag 41, and does not adversely affect the inflation of the airbag 41.

The airbag unit 40 includes the airbag 41, an inflator 42 that supplies an inflation gas to the airbag 41, the case 43 that holds the airbag 41 and the inflator 42, and a retainer 44 housed inside the airbag 41.

The inflator 42 is a substantially cylindrical member that generates and releases an inflation gas, and has an ejection port 42a that ejects the inflation gas toward the rear side. The portion, of the inflator 42, where the ejection port 42a is formed is disposed inside the airbag 41. The inflator 42 includes a flange portion 42b, as a portion coupled to the case 43, extending in the radial direction of the cylindrical shape from a face on which the ejection port 42a is formed. In addition, the inflator 42 is electrically connected to control device (not illustrated), and operates by receiving a signal from the control device to generate an inflation gas.

The airbag 41 is a bag-shaped member made of synthetic fiber or the like, and is housed inside the steering wheel 10 in a folded state. The front portion of the airbag 41 in the folded state has a gas inlet 41h, which is an opening through which a portion where the ejection port 42a of the inflator 42 is formed is inserted. The airbag 41 at the time of completion of inflation is configured to cover the entire grip portion 1 of the steering wheel 10 from rear (see FIG. 3).

The case 43 is a member made of sheet metal, and holds the airbag 41, the inflator 42, and the pad 5. The case 43 is fixed to the core material 3x1 of the spoke portion 3 via a pin of a horn switch unit (not illustrated). The case 43 includes a rectangular parallelepiped bottom wall portion 43a and a side wall portion 43b extending rearward from an outer edge of the bottom wall portion 43a. The bottom wall portion 43a has an insertion hole 43a1 through which the inflator 42 is inserted and an insertion hole 43a2 through which the coupling portion 5b of the pad 5 is inserted. The coupling portion 5b of the pad 5 is inserted into the insertion hole 43a2 of the case 43, and the coupling portion 5b is retained by the side wall portion 43b, whereby the pad 5 is held by the case 43.

The retainer 44 is a substantially square annular member made of metal used for fixing the airbag 41 and the like, and is disposed inside the airbag 41. The retainer 44 has an insertion hole 44a through which the inflator 42 is inserted. When the airbag 41 and the inflator 42 are fixed to the case 43, the inflator 42 is inserted into the insertion hole 43al of the case 43, the gas inlet 41h of the airbag 41, and the insertion hole 44a of the retainer 44, and bolts 45 are inserted into screw holes formed in the peripheral edge of the gas inlet 41h of the airbag 41, the bottom wall portion 43a of the case 43, and the flange portion 42b of the inflator 42, and are fastened with nuts 46. As a result, the peripheral edge of the gas inlet 41h of the airbag 41 is sandwiched between the front face of the retainer 44 and the rear face of the bottom wall portion 43a of the case 43, and the flange portion 42b of the inflator 42 is sandwiched between the front face of the bottom wall portion 43a and the nut 46. In this manner, the airbag 41 and the inflator 42 are fixed to the bottom wall portion 43a of the case 43.

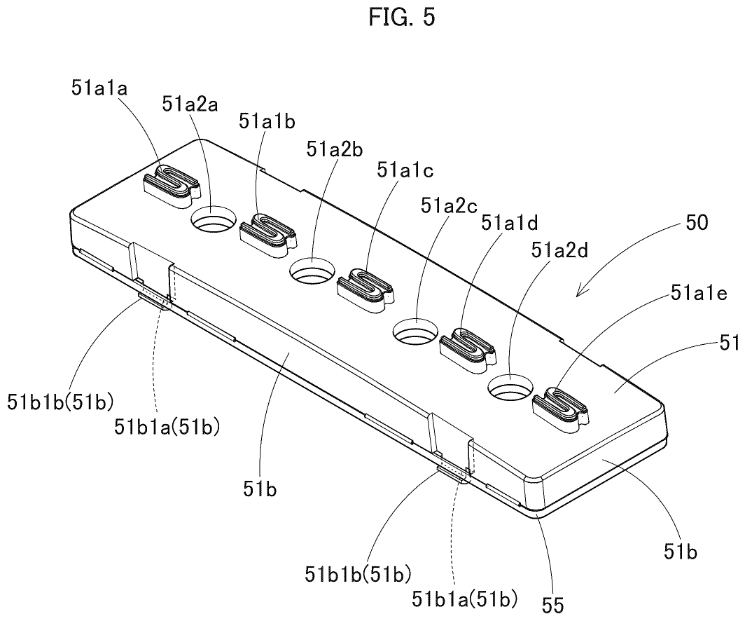

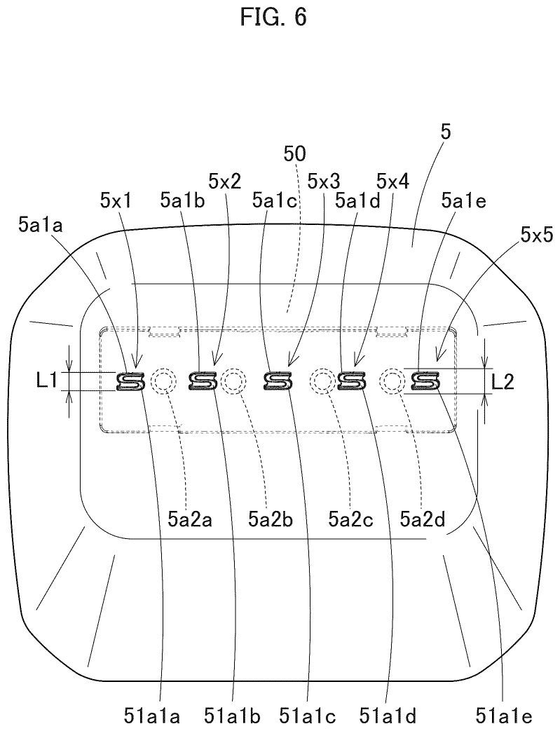

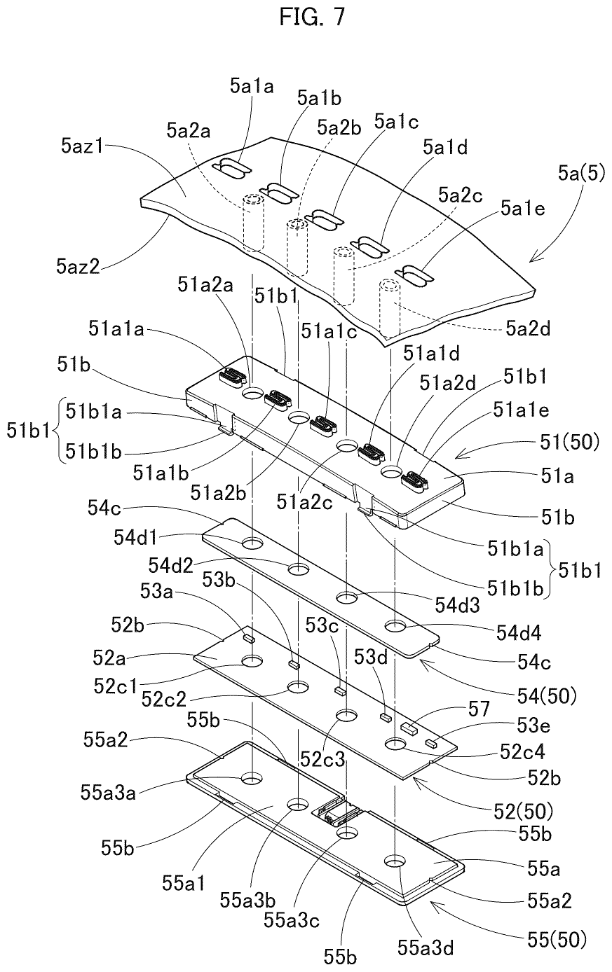

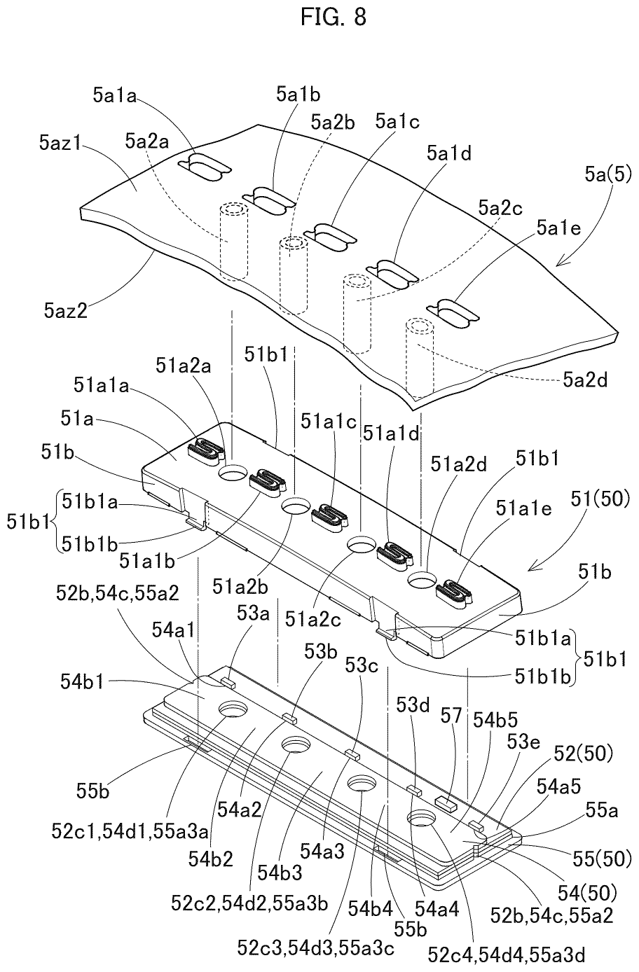

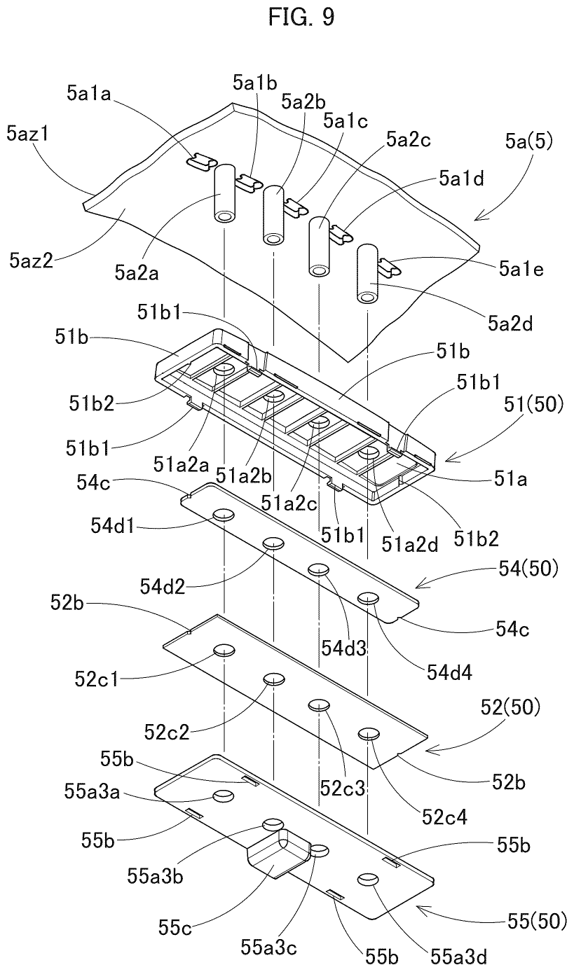

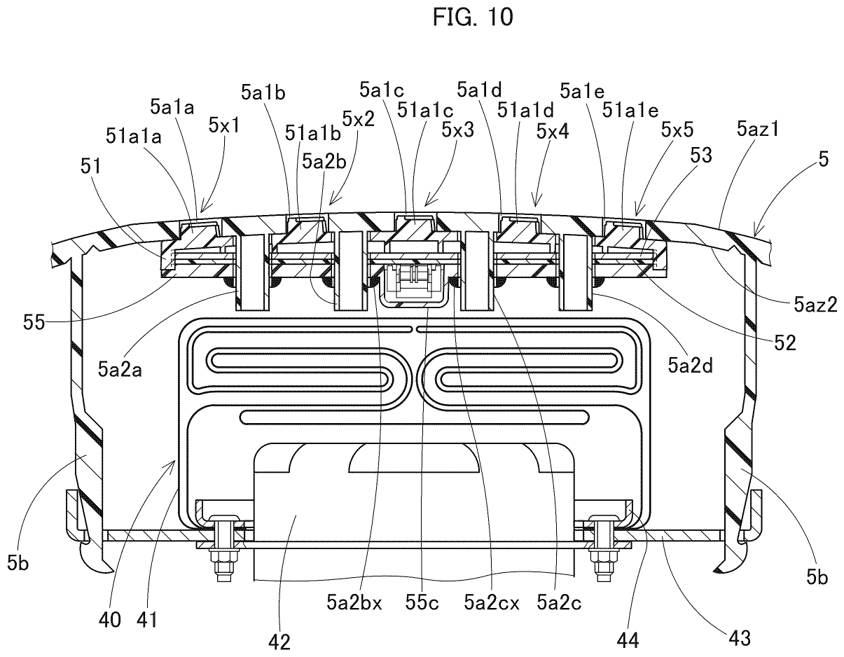

Next, a detailed configuration of the lighting units 5x1 to 5x5 of the pad 5 and the optical unit 50 will be described. FIG. 5 is a perspective view of the optical unit 50. FIG. 6 is a front view of the optical unit 50 and the pad 5. FIGS. 7 and 8 are exploded perspective views of the optical unit 50 and the pad 5 when viewed from the upperside, and FIG. 8 illustrates a state in which a circuit board 52 and a light guide 54 are assembled to a holder member 55. FIG. 9 is an exploded perspective view of the optical unit 50 and the pad 5 when viewed from the reverse side. FIG. 10 is an enlarged cross-sectional view of the surroundings of the lighting units 5x1 to 5x5 and the optical unit 50 of the steering wheel 10.

As illustrated in FIGS. 5 to 10, the optical unit 50 includes an emblem 51, the circuit board 52, five LEDs 53a to 53e mounted on the circuit board 52, the light guide 54 that guides light emitted from the five LEDs 53a to 53e, and the holder member 55. These members are disposed in the order of the emblem 51, the light guide 54, the circuit board 52 on which the LEDs 53a to 53e are mounted, and the holder member 55 from the rear side toward the front side.

The cover portion 5a of the pad 5 has five through holes 5a1a to 5a1e that are hollowed out in accordance with the character shape of “S” and penetrate in the front-rear direction juxtaposed in the left-right direction. On the reverse side 5az2 (front face) of the cover portion 5a of the pad 5, four protrusions 5a2a to 5a2d protruding forward are juxtaposed in the left-right direction. All the protrusions 5a2a to 5a2d have the same shape and are integrally molded with the cover portion 5a of the pad 5. In the present embodiment, the protrusions 5a2a to 5a2d are formed in a cylindrical shape having a width dimension of L2 in the up and down direction (see FIG. 6). All the through holes 5a1a to 5a1e have the same width dimension of L1 in the up and down direction, and the width L2 of the protrusions 5a2a to 5a2d is set to be equal to or larger than the width L1 of the through holes 5a1a to 5a1e.

When viewed from the front-rear direction, the protrusion 5a2a of the pad 5 is disposed between the through hole 5a1a and the through hole 5a1b. In the present embodiment, since the through holes 5a1a and 5a1b are disposed adjacent to each other in the left-right direction, the protrusion 5a2a is disposed between the through holes 5a1a and 5a1b in the left-right direction. Similarly, in the left-right direction, the protrusion 5a2b is disposed between the through hole 5a1b and the through hole 5a1c, the protrusion 5a2c is disposed between the through hole 5a1c and the through hole bald, and the protrusion 5a2d is disposed between the through hole 5a1d and the through hole 5a1e.

Here, as will be described later, since the lighting unit 5x1 of the pad 5 is lit by the light emitted rear of the pad 5 through the through hole 5a1a, the lighting unit 5x1 can also be regarded as the through hole 5a1a. Similarly, the lighting unit 5x2 can be regarded as the through hole 5a1b, the lighting unit 5x3 can be regarded as the through hole 5a1c, the lighting unit 5x4 can be regarded as the through hole 5a1d, and the lighting unit 5x5 can be regarded as the through hole 5a1e. Therefore, it can be said that the protrusion 5a2a is positioned between the lighting units 5x1 and 5x2, the protrusion 5a2b is positioned between the lighting units 5x2 and 5x3, the protrusion 5a2c is positioned between the lighting units 5x3 and 5x4, and the protrusion 5a2d is positioned between the lighting units 5x4 and 5x5 when viewed from the front-rear direction.

The emblem 51 (translucent member) is a member having high translucency as a whole, and is attached to the reverse side 5az2 of the cover portion 5a of the pad 5. The emblem 51 has a base portion 51a having a substantially rectangular shape and a side wall portion 51b extending forward from each side of the base portion 51a.

The base portion 51a of the emblem 51 has five projections 51a1a to 51a1e (fitting portions) protruding backward in a shape corresponding to the display character of the lighting units 5x1 to 5x5 of the pad 5. That is, each of the projection 51a1a, the projection 51a1b, the projection 51a1c, the projection 51a1d, and the projection 51a1e protrudes in the character shape f “S” The projections 51a1a to 51a1e are arranged in parallel in the left-right direction.

The projections 51a1a to 51a1e Are Fitted Into the through holes 5a1a to 5a1e from forward so that the through holes 5a1a to Sale of the pad 5 are filled with the projections. In the present embodiment, the rear ends of the projections 51a1a to 51a1e are positioned in front of the upperside 5az1 (the rear face of the pad) of the cover portion 5a of the pad 5. That is, the projections 51a1a to 51a1e are located at positions slightly recessed from the through holes 5a1a to 5a1e when viewed from the driver M. However, the projections 51a1a to 51a1e may be configured to be flush with the upperside 5az1 of the cover portion 5a or may be configured to bounce rearward with respect to the upperside 5az1.

In the base portion 51a of the emblem 51, an insertion hole 51a2a that penetrates in the front-rear direction and through which the protrusion 5a2a of the pad 5 is inserted is provided between the projections 51a1a and 51a1b adjacent to each other in the left-right direction. Similarly, in the base portion 51a, insertion holes 51a2b to 51a2d through which the protrusions 5a2b to 5a2d of the pad 5 are inserted are provided between the projections 51a1b and 51a1c, between the projections 51a1c and 51a1d, and between the projections 51a1d and 51a1e, respectively.

The side wall portion 51b of the emblem 51 has four claw portions 51b1 protruding forward and two positioning projections 51b2 protruding in a V shape in the left-right direction. Each of the claw portions 51b1 includes an insertion portion 51b1a extending in the front-rear direction and a retaining portion 51b1b bent in the up and down direction from the distal end of the insertion portion 51b1a and retaining the insertion portion 51b1a. In the present embodiment, two claw portions 51b1 are disposed on each of the side wall portions 51b extending forward from two long sides of the rectangular base portion 51a, and one positioning projection 51b2 is disposed on each of the side wall portions 51b extending forward from two short sides of the base portion 51a. However, the present invention is not limited thereto, and the claw portion 51b1 and the positioning projection 51b2 may be provided on the base portion 51a and another side wall portion 51b.

The circuit board 52 is a rectangular parallelepiped member having a wide width in the left-right direction. The rear face of the circuit board 52 is a mounting face 52a, and five LEDs 53a to 53e and a control component 57 such as a CPU that controls lighting of the LEDS 53a to 53e are mounted on the mounting face 52a. The LEDs 53a to 53e are disposed side by side in the left-right direction on the mounting face 52a, and each emit visible light according to the control of the control component 57. Here, the LED 53a is a light source that emits light for lighting the lighting unit 5x1 of the pad 5. The LED 53b is a light source that emits light for lighting the lighting unit 5x2 of the pad 5. Similarly, the LEDs 53c to 53e are light sources that emit light for lighting the lighting units 5x3 to 5x5 of the pad 5, respectively. The LEDS 53a to 53e are examples of a first light source and a second light source disposed at a position different from that of the first light source. In the present embodiment, the LEDs 53a to 53e are used as the light source, but another light source may be used as long as it is a member that emits visible light.

A positioning groove 52b cut out in a V shape is provided in each of a right end portion and a left end portion of the circuit board 52. By fitting the positioning projection 51b2 of the emblem 51 into the positioning groove 52b, the emblem 51 and the circuit board 52 are positioned. The circuit board 52 has insertion holes 52c1 to 52c4 through which the protrusions 5a2a to 5a2d of the pad 5 are inserted.

The light guide 54 is a member made of a synthetic resin that is disposed in front of the emblem 51 and guides the light emitted from the LEDs 53a to 53e while diffusing the light inside. The light emitted downward from the LEDs 53a to 53e enters the upper face of the light guide 54, is deflected by a deflection unit (not illustrated), and is emitted forward from the front face of the light guide 54.

Specifically, the light emitted from the LED 53a is incident on an incident face 54a1 of the light guide 54, and is emitted from an emission face 54b1 disposed at a position corresponding to the projection 51a1a of the emblem 51. In addition, the light emitted from the LED 53b is incident on an incident face 54a2 of the light guide 54, and is emitted from an emission face 54b2 disposed at position corresponding to the projection 51a1b of the emblem 51. Similarly, the light emitted from the LEDs 53c to 53e is incident on incident faces 54a3 to 54a5 of the light guide 54, respectively, and is emitted from the emission faces 54b3 to 54b5 disposed at positions corresponding to the projections 51a1c to 51a1e of the emblem 51, respectively. Note that the deflection unit of the present embodiment is a textured portion formed in the light guide 54, and deflects light by reflecting the light on the inner wall of the textured portion.

The light guide 54 has a positioning groove 54c cut out in a V shape at a right end portion and a left end portion. By fitting a positioning projection 51b2 of the emblem 51 into the positioning groove 54c, the emblem 51 and the light guide 54 are positioned. The light guide 54 has insertion holes 54d1 to 54d4 that penetrate in the front-rear direction and through which the protrusions 5a2a to 5a2d of the pad 5 are inserted, respectively.

The holder member 55 (holding member) is a synthetic resin member disposed in front of the circuit board 52, and has a substantially rectangular parallelepiped shape with a wide outer shape in the left-right direction. The holder member 55 includes a pedestal 55a which protrudes rearward from the rear face and has a placement face 55a1 on which the circuit board 52 is placed, four engagement holes 55b (engaged portions) which are disposed in the vicinity of the edge of the holder member 55 and penetrate in the front-rear direction and with which the four claw portions 51b1 of the emblem 51 are engaged, and a projection 55c which protrudes forward from the front face of the holder member 55.

When the claw portion 51b1 of the emblem 51 is engaged with the engagement hole 55b of the holder member 55, the holder member 55 and the emblem 51 are coupled. As a result, a box-shaped housing that houses the light guide 54 and the circuit board 52 on which the LEDs 53a to 53e are mounted is formed by the holder member 55 and the emblem 51. Specifically, the front face of the housing is the holder member 55, the rear face is the base portion 51a of the emblem 51, and the four side faces are the side wall portions 51b of the emblem 51.

The pedestal 55a has a positioning groove 55a2 cut out in a V shape at each of a right end portion and a left end portion. By fitting the positioning projection 51b2 of the emblem 51 into the positioning groove 55a2, the emblem 51 and the holder member 55 are positioned. Further, the pedestal 55a has insertion holes 55a3a to 55a3d which penetrate in the front-rear direction and through which the protrusions 5a2a to 5a2d of the pad 5 are inserted.

Next, method of assembling the optical unit 50 to the pad 5 will be described. An operator who performs assembly first places the emblem 51 on a floor or a desk, and places the light guide 54 on the emblem 51. At this time, the operator fits the positioning projection 51b2 of the emblem 51 into the positioning groove 54c of the light guide 54. Next, while fitting the positioning projection 51b2 of the emblem 51 into the positioning groove 52b of the circuit board 52, the operator places the circuit board 52 on which the LEDs 53a to 53e and the control component 57 are mounted on the light guide 54.

Next, while fitting the positioning projection 51b2 of the emblem 51 into the positioning groove 55a2 of the holder member 55, the operator places the placement face 55a1 of the holder member 55 on the circuit board 52. As a result, the emblem 51, the circuit board 52, the light guide 54, and the insertion holes 51a2a to 51a2d, 52c1 to 52c4, 54d1 to 54d4, and 55a3a to 55a3d of the holder member 55 are aligned and communicate with each other.

Next, the operator engages the claw portion 51b1 of the emblem 51 with the engagement hole 55b of the holder member 55. Specifically, the insertion portion 51b1a and the retaining portion 51b1b are inserted into the engagement hole 55b from rear so that the retaining portion 51b1b penetrates to the front of the engagement hole 55b while elastically deforming the retaining portion 51b1b of the claw portion 51b1 so as to be parallel to the direction in which the insertion portion 51b1a extends. As a result, the retaining portion 51b1b bouncing forward with respect to the engagement hole 55b is restored, the retaining portion 51b1b is caught by a portion around the engagement hole 55b of the holder member 55 in front of the engagement hole 55b, and the insertion portion 51b1a positioned inside the engagement hole 55b is retained. In this manner, the claw portion 51b1 is engaged with the engagement hole 55b, and the optical unit 50 is unitized.

Next, the protrusions 5a2a to 5a2d of the pad 5 are inserted into the insertion holes 51a2a to 51a2d, 52c1 to 52c4, 54d1 to 54d4, and 55a3a to 55a3d of the emblem 51 of the optical unit 50, the circuit board 52, the light guide 54, and the holder member 55. Thereafter, portions, of the protrusions 5a2a to 5a2d of the pad 5, bouncing forward from the holder member 55 are melted by heat, vibration, or the like, and the protrusions 5a2a to 5a2d are welded (coupled) to the holder member 55. At this time, melting portions 5a2bx and 5a2cx of the protrusions 5a2b and 5a2c sandwich the projection 55c of the holder member 55 from the left-right direction. That is, the protrusions 5a2b and 5a2c (first protrusion and second protrusion) of the pad 5 sandwich the projection 55c of the holder member 55 from the left-right direction. In this manner, the optical unit 50 is assembled to the pad 5.

In the optical unit 50 assembled as described above, the LEDs 53a to 53e emit light according to the control of the control component 57. The light emitted from the LED 53a is incident on the incident face 54a1 of the light guide 54 and emitted from the emission face 54b1. Thereafter, this light passes through the projection 51a1a of the emblem 51, and is emitted to the outside of the pad 5, specifically, toward the rear where the driver M is located via the through hole 5a1a of the pad 5. In this manner, the lighting unit 5x1 of the pad 5 is lit.

In addition, the light emitted from the LED 53b is first incident on the incident face 54a2 of the light guide 54 and is emitted from the emission face 54b2. Thereafter, the light passes through the projection 51a1b of the emblem 51, and is radiated to the outside of the pad 5 via the through hole 5a1b of the pad 5. In this manner, the lighting unit 5x2 of the pad 5 is lit.

Similarly, the light emitted from the LEDs 53c to 53e is incident on the incident faces 54a3 to 54a5 of the light guide 54, respectively, and emitted from the emission faces 54b3 to 54b5. Thereafter, the light passes through the projections 51a1c to 51a1e of the emblem 51, and is radiated to the outside of the pad 5 via the through holes 5a1c to 5a1e of the pad 5. In this manner, the lighting units 5x3 to 5x5 of the pad 5 are lit. As a result, the lighting units 5x1 to 5x5 of the pad 5 are lit so that the characters “SSSSS” are displayed as a whole.

Here, in the configuration of the present embodiment, the protrusion 5a2a disposed between the lighting units 5x1 and 5x2 of the pad 5 is welded and coupled to the holder member 55 that holds the circuit board 52. Similarly, the protrusion 5a2b disposed between the lighting units 5x2 and 5x3, the protrusion 5a2c disposed between the lighting units 5x3 and 5x4, and the protrusion 5a2d disposed between the lighting units 5x4 and 5x5 are coupled to the holder member 55. Accordingly, the following effects are obtained.

That is, the center position of the optical unit 50 is disposed in the vicinity of the lighting units 5x1 to 5x5 in consideration of the role of the optical unit 50 of lighting the lighting units 5x1 to 5x5. Therefore, the positions of the protrusions 5a2a to 5a2d are also disposed near the center of the optical unit 50. Therefore, if the protrusions 5a2a to 5a2d and the holder member 55 are not coupled, the pad 5 and the holder member 55 are not coupled near the center of the optical unit 50. In this case, even when the pad 5 and the holder member 55 are coupled at another position, the coupling strength between the entire optical unit 50 and the pad 5 is weak, and there is a possibility that the optical unit 50 is detached from the pad 5 when an external force is applied to the steering wheel 10.

On the other hand, in the present embodiment, the protrusions 5a2a to 5a2d of the pad 5 are coupled to the holder member 55. Therefore, according to the steering wheel 10 of the present embodiment, the pad 5 and the holder member 55 can be firmly coupled. Thus, it is possible to suppress an adverse effect on lighting of the lighting units 5x1 to 5x5 by the positional relationship between the pad 5 and the holder member 55 being shifted when an external force is applied to the steering wheel 10, and detachment of the optical unit 50 from the pad 5. In the present embodiment, since the protrusions 5a2b and 5a2c of the pad 5 sandwich the projection 55c of the holder member 55, the pad 5 and the holder member 55 are more firmly coupled.

When viewed from the front-rear direction, the protrusion 5a2a of the pad 5 is disposed at a position between the lighting units 5x1 and 5x2. Therefore, the light emitted from the LED 53a and directed to the through hole 5a1b of the pad 5 not to the through hole 5a1a intended in design can be blocked by the protrusion 5a2a. The same applies to the protrusions 5a2b to 5a2d of the pad 5. Therefore, the amount of light emitted from the lighting units 5x1 to 5x5 of the pad 5 can be made uniform.

Specifically, in the present embodiment, the width L2 of the protrusions 5a2a to 5a2d of the pad 5 in the up and down direction is set to be equal to or larger than the width L1 of the lighting units 5x1 to 5x5 in the up and down direction. Therefore, it is possible to effectively block the light emitted from the LEDs 53a to 53e and directed to the through holes 5a1a to 5a1e of the pad 5 unintended in design.

In the present embodiment, the lighting units 5x1 to 5x5 are disposed in parallel in the left-right direction, but the present invention is not limited thereto. That is, as long as the protrusion 5a2a to the protrusion 5a2d disposed between the lighting units 5x1 to 5x5 are coupled to the holder member 55, for example, the lighting units 5x1 to 5x5 may be disposed in parallel in the up and down direction. These coupling methods are not limited to welding, but may be screw fixing the like. Even with such a configuration, the same effects as described above can be obtained.

Even when some of the protrusions 5a2a to 5a2d are not coupled to the holder member 55, when some of the other protrusions are coupled, the above effect can be obtained although there is a slight change in coupling strength. In addition, in order to further increase the coupling strength between the pad 5 and the holder member 55, the pad 5 and the holder member 55 may be coupled at a position other than a position between the lighting units 5x1 to 5x5 in addition to those of the protrusion 5a2a to the protrusion 5a2d. In a case where the lighting units 5x1 to 5x5 are disposed in parallel in the up and down direction, when the width of each of the protrusions 5a2a to 5a2d of the pad 5 in the left-right direction is equal to or larger than the width of each of the lighting units 5x1 to 5x5 in the left-right direction in the same manner as described above, the light shielding performance of the protrusions 5a2a to 5a2d can be improved.

The emblem 51, the circuit board 52, the light guide 54, and the holder member 55 have insertion holes 51a2a to 51a2d, 52c1 to 52c4, 54d1 to 54d4, and 55a3a to 55a3d through which the protrusions 5a2a to 5a2d of the pad 5 are inserted. Therefore, mutual positional accuracy of the pad 5, the emblem 51, the circuit board 52, the light guide 54, and the holder member 55 can be enhanced.

In addition, the emblem 51 has the claw portion 51b1 extending forward, and the holder member 55 has the engagement hole 55b with which the claw portion 51b1 is engaged. The holder member 55 is coupled to the emblem 51 by engaging the claw portion 51b1 with the engagement hole 55b. Accordingly, the following effects are obtained.

That is, it is assumed that the relationship between the claw portion 51b1 and the engagement hole 55b is reversed, the holder member 55 has a claw portion extending rearward, the emblem 51 has an engagement hole penetrating in the front-rear direction, and the emblem 51 and the holder member 55 are coupled by their engagement. In this case, when the claw portion of the holder member 55 is inserted into the engagement hole of the emblem 51 from forward and the distal end thereof bounces rear of the engagement hole, it is necessary to provide a gap between the pad 5 and the emblem 51 in order to provide an arrangement space of the distal end of the claw portion bouncing to the rear side. In addition, in the emblem 51, even when the engaged portion with which the claw portion of the holder member 55 is engaged is not the through hole, in a case where the claw portion of the holder member 55 is locally recessed rearward for insertion, it is necessary to provide a gap between the pad 5 and the emblem 51 in the same manner as described above. In this case, light may leak out from the gap, or foreign matter such as dust may come in from the gap and block the light, so that the amount of light emitted rearward from the lighting units 5x1 to 5x5 of the pad 5 may be reduced.

On the other hand, in the present embodiment, the emblem 51 has the claw portion 51b1 extending forward, and the holder member 55 has the engagement hole 55b (engaged portion) with which the claw portion 51b1 of the emblem 51 is engaged. Therefore, when the claw portion 51b1 is engaged with the engagement hole 55b at the time of coupling the two, since the distal end of the claw portion 51b1 is disposed close to the holder member 55, it is not necessary to provide a gap between the pad 5 and the emblem 51 in order to secure an arrangement space of the distal end of the claw portion 51b1. Therefore, according to the steering wheel 10 Of the present embodiment, it is possible to suppress formation of a gap between the pad 5 and the emblem 51. Therefore, it is possible to suppress a decrease in the amount of light emitted rearward from the lighting units 5x1 to 5x5 of the pad 5 due to leakage of light from the gap or blocking of light due to entry of foreign matter such as dust from the gap.

In the present embodiment, the engaged portion of the holder member 55 with which the claw portion 51b1 of the emblem 51 engages is the engagement hole 55b penetrating in the front-rear direction, and the distal end of the claw portion 51b1 engaged with the engagement hole 55b is disposed in front of the engagement hole 55b. However, the present invention is not limited thereto, and the engaged portion of the holder member 55 with which the claw portion 51b1 is engaged does not necessarily penetrate in the front-rear direction. That is, when the emblem 51 has the claw portion 51b1 at least extending forward and the holder member 55 has the engaged portion with which the claw portion 51b1 is engaged, it is not necessary to provide a space for disposing the distal end of the claw portion 51b1 between the emblem 51 and the pad 5 at the time of coupling them, and thus the above effect can be obtained. However, as in the present embodiment, the retaining portion 51b1b of the claw portion 51b1 is caught by a portion around the engagement hole 55b of the holder member 55 in front of the engagement hole 55b, so that the insertion portion 51b1a can be retained to firmly couple the emblem 51 and the holder member 55 while obtaining the above effect, which is preferable.

What is claimed is:

1. A steering device mounted on a vehicle, the steering device comprising:
a boss portion coupled to a steering shaft of the vehicle;
a pad that covers the boss portion from rear, the pad including a first lighting unit, a second lighting unit disposed at a position different from a position of the first lighting unit, and a protrusion disposed between the first lighting unit and the second lighting unit when viewed from a front-rear direction, the protrusion protruding forward from a front face of the pad;
a first light source that is disposed in front of the pad and emits light for lighting the first lighting unit;
a second light source that is disposed at a position, in front of the pad, different from a position of the first light source and emits light for lighting the second lighting unit;
a circuit board on which the first light source and the second light source are mounted; and
a holding member that is coupled to the protrusion and holds the circuit board.

2. The steering device according to claim 1, wherein the first lighting unit and the second lighting unit are disposed adjacent to each other in a left-right direction.

3. The steering device according to claim 2, wherein a width of the protrusion in an up and down direction is equal to or larger than widths of the first lighting unit and the second lighting unit in the up and down direction.

4. The steering device according to claim 1, wherein the circuit board has an insertion hole through which the protrusion is inserted.

5. The steering device according to claim 1, wherein each of the first lighting unit and the second lighting unit is a character.

6. The steering device according to claim 1, wherein the pad further includes
a third lighting unit disposed at a position different from a position of each of the first lighting unit and the second lighting unit, and
a second protrusion that is disposed between the second lighting unit and the third lighting unit when viewed from a front-rear direction, protrudes forward from a front face of the pad, and is different from a first protrusion that is the protrusion, wherein
the holding member includes a projection protruding forward from a front face of the holding member, and wherein
the first protrusion and the second protrusion sandwich the projection.

7. The steering device according to claim 1, wherein the steering device further includes
a translucent member attached to a front face of the pad, the translucent member including a translucent fitting portion fitted from forward into a through hole formed in the pad, and a claw portion extending forward, and wherein
the holding member has an engaged portion with which the claw portion is engaged, is disposed in front of the translucent member, and is coupled to the translucent member by the claw portion being engaged with the engaged portion.

8. The steering device according to claim 7, wherein
the engaged portion is an engagement hole penetrating in a front-rear direction, and wherein
the claw portion in a state of being engaged with the engagement hole includes an insertion portion positioned inside the engagement hole, and a retaining portion that is disposed in front of the insertion portion and the engagement hole and is caught by a portion around the engagement hole of the holding member to retain the insertion portion.
